(19) United States
(12) Patent Application Publication
(10) Pub. No.: US 2011/0282556 A1
(43) Pub. Date: Nov. 17, 2011

(54) Depth Adjustment of Trailing Arm Furrow Openers

(75) Inventors: Robert Klenz, St. Brieux (CA); Robert Cochran, St. Brieux (CA); Mark Cresswell, St. Brieux (CA)

(73) Assignee: Bourgault Industries Ltd., St. Brieux (CA)

(21) Appl. No.: 12/874,477

(22) Filed: Sep. 2, 2010

(30) Foreign Application Priority Data
May 14, 2010 (CA) 2704416

(51) Int. Cl. G06F 19/00; A01C 13/00; A01C 5/06

(52) U.S. Cl. 701/50; 111/153

(57) ABSTRACT

A furrow opener apparatus has a trailing arm pivotally attached to a seeding implement and extending rearward. A packer wheel is rotatably mounted at a rear end of the trailing arm, and a furrow opener is mounted to the trailing arm forward of, and in alignment with, the packer wheel. A bias element exerts a downward bias force forcing the packer wheel downward against the ground. An actuator is operative to move the packer wheel up and down through a range from a lowest vertical position with respect to the furrow opener to a highest vertical position with respect to the furrow opener. A remote control is operative to activate the actuator from the towing vehicle, and a microprocessor is programmed to adjust all furrow openers on the seeding implement by an equal amount when desired.

This invention is in the field of agricultural implements and in particular a trailing arm seeding apparatus with remote depth control and a seeding apparatus where all furrow openers on the seeding implement are adjusted by an equal amount when desired.

### BACKGROUND

Seeding implements typically comprise a frame adapted for travel over the ground, a plurality of furrow opener assemblies attached to the frame to open one or more furrows, and a distribution system for depositing agricultural materials such as seed and fertilizer into the furrows.

The furrow opener assemblies vary widely in design, but an important object of any design is to maintain the depth of the furrow as constant as possible, such that seed placement is at a constant depth to ensure uniform plant emergence as nearly as possible. The actual furrow opening element can be a hoe or knife type that essentially drags through the soil to form the furrow, or a disc opener comprising a disc which rolls through the soil at an angle to the travel direction to form the furrow. A tube is located to drop seed and fertilizer behind the disc and into the furrow.

The seeding depth for different crops varies, typically depending on seed size with larger seeds placed deeper than smaller seeds. Seeding implements are known where the furrow openers are mounted on a frame and are in substantially a fixed vertical relationship with the frame. Thus moving the frame vertically adjusts the depth of all the furrow openers and all the furrows.

In planter assemblies, such as found on corn planters, each assembly supports the furrow opener, hoppers for carrying seed and fertilizer, and a metering system to deliver this material to the furrow. These planter assemblies are typically pivotally attached to the frame of the seeding implement so as to be able to float up and down with respect to the frame, and commonly include front and rear wheels to support the assembly for travel over the ground, with the rear wheels typically acting as packer wheels. Such assemblies are disclosed for example in U.S. Pat. No. 7,191,715 to Wendte et al. and U.S. Pat. No. 5,351,635 to Hulicsko. In order to change the seeding depth on a seeding implement comprising a number of such assemblies, each planter assembly must adjusted individually to change the furrow depth across the width of the machine.

Amazone Ltd. of Hasbergen-Gaste, Germany manufactures a planter unit of this type that includes an actuator that can be activated by a computer on a tractor towing the seeder to move the furrow opening discs up and down to adjust the furrow depth. The required depth for each furrow opener is determined by a soil map of soil conditions, or sensed soil conditions, and a sensor on each planter unit determines the actual seeding depth and the computer compares the actual to the desired seeding depth and makes adjustments accordingly.

Yetter Manufacturing of Colchester, Ill. makes an assembly with a pair of trash clearing discs mounted in front of the furrow opener, and an actuator that can be activated by the operator to move the trash clearing discs up or down. The vertical position of such trash clearing discs significantly affects their effectiveness and so remote fine tuning of each set of discs is beneficial.

Independent furrow opener assemblies, such as the trailing arm furrow opener assembly, have become increasingly popular as more precise control of the furrow depth is possible than can be attained where the furrow openers are fixed to the frame, and the frame moves up and down. In these assemblies only the furrow opener is mounted on the assembly, and agricultural products such as seed and fertilizer are delivered to the furrow through a tube from the seeding implement.

One popular style of independent furrow opener assembly comprises a trailing arm. The front end of the trailing arm is pivotally attached to the seeder frame such that the arm extends generally rearward and downward from the frame and can pivot up and down with respect to the seeder frame. A packer wheel is then rotatably attached to support the rear end of the trailing arm. A furrow opener is attached to the trailing arm ahead of the packer wheel such that the vertical position of the bottom of the furrow opener with respect to the bottom of the packer wheel can be fixed at a desired location to substantially set the depth of the furrow. A bias element is provided to force the trailing arm downward to push the furrow opener into the soil and force the packer wheel against the ground.

The packer wheel pushes down the soil over the seed in the furrow and the bottom of the packer wheel corresponds to the soil surface. The depth of the furrow is substantially determined by the vertical distance that the bottom end of the furrow opener extends below the bottom of the packer wheel. Such a trailing arm furrow opener assembly is disclosed for example in U.S. Pat. No. 7,159,523 to Bourgault et al., particularly in FIG. 1 thereof. and in U.S. Pat. No. 5,396,851 to Beaujot. U.S. Pat. No. 7,261,048 to Hantke discloses a trailing arm type furrow opener assembly with a parallel link trailing arm.

In these trailing arm furrow opener assemblies, each assembly must be adjusted to vary the depth of seeding. A typical modern seeding implement will typically have three or four parallel rows of furrow opener assemblies arranged from the front to the rear of the implement frame. In wider implements, there can be 80 or more furrow opener assemblies mounted on the implement frame. Typically as well there will be at least one air distribution system with a hose attached to each furrow opener assembly, and often a second air distribution system for a second agricultural product such as fertilizer with two hoses attached to each furrow opener assembly, and the attendant distribution towers. As a result at least some of the furrow opener assemblies will be quite difficult to access and adjust. Thus changing the depth of seeding on a typical seeding implement with trailing arm furrow opener assemblies is arduous and time consuming.

### SUMMARY OF THE INVENTION

It is an object of the present invention to provide a seeding apparatus with trailing arm furrow opener assemblies that overcomes problems in the prior art.

In a first embodiment the present invention provides a furrow opener apparatus comprising a trailing arm adapted at a front end thereof to be pivotally attached about an arm pivot axis to an implement frame supported for movement along the ground by a towing vehicle in an operating travel direction, the arm pivot axis oriented substantially horizontally and transverse to the operating travel direction, and the trailing arm extending rearward from the implement frame. A packer wheel is rotatably mounted at a rear end of the trailing arm, and a furrow opener is mounted to the trailing arm forward of, and substantially in alignment with, the packer wheel. A bias element is operative, in an operating mode, to exert a downward bias force on the trailing arm with respect to an attached implement frame such that the packer wheel is forced downward against the ground. An actuator is operative to move the packer wheel up and down through a range from a lowest vertical position with respect to the furrow opener to a highest vertical position with respect to the furrow opener, and a remote control is operative to activate the actuator from the towing vehicle.

In a second embodiment the present invention provides a seeding apparatus comprising an implement frame comprising a plurality of frame members, the implement frame supported for movement along the ground by a towing vehicle in an operating travel direction. A trailing arm is pivotally attached at a front end thereof about an arm pivot axis oriented substantially horizontally and transverse to the operating travel direction such that the trailing arm extends rearward from the frame member, and a packer wheel is rotatably mounted at a rear end of the trailing arm. A furrow opener is mounted to the trailing arm forward of, and substantially in alignment with, the packer wheel. A bias element is operative, in an operating mode, to exert a downward bias force on the trailing arm with respect to the implement frame such that the packer wheel is forced downward against the ground. An actuator is operative to move the packer wheel up and down through a range from a lowest vertical position with respect to the furrow opener to a highest vertical position with respect to the furrow opener. A remote control comprising a microprocessor is operative to activate the actuators of the plurality of furrow opener assemblies to move the packer wheels of all the furrow opener assemblies up or down an equal selected distance.

In a third embodiment the present invention provides a method of adjusting a depth of seeding on a seeding apparatus. The method comprises providing an implement frame comprising a plurality of frame members, and supporting the implement frame for movement along the ground by a towing vehicle in an operating travel direction; attaching a plurality of furrow opener assemblies to the implement frame, each furrow opener assembly comprising: a trailing arm pivotally attached at a front end thereof to a frame member about an arm pivot axis oriented substantially horizontally and transverse to the operating travel direction such that the trailing arm extends rearward from the frame member, a packer wheel rotatably mounted at a rear end of the trailing arm, a furrow opener mounted to the trailing arm forward of, and substantially in alignment with, the packer wheel, a bias element operative, in an operating mode, to exert a downward bias force on the trailing arm such that the packer wheel is forced downward against the ground, and an actuator operative to move the packer wheel up and down through a range from a lowest vertical position with respect to the furrow opener to a highest vertical position with respect to the furrow opener; and providing a remote control comprising a microprocessor and programming the microprocessor to activate the actuators of the plurality of furrow opener assemblies to move the packer wheels of all the furrow opener assemblies up or down an equal selected distance.

The present invention provides depth adjustment for independent trailing arm type furrow openers allowing an operator to quickly change the seeding depth of all the furrow openers by an equal amount, instead of going to each furrow opener and manually attending to the adjustment. A microprocessor is programmed to activate the actuators to change the working depth of all the furrow openers by the same amount. The microprocessor could activate the actuators simultaneously or sequentially to change the seeding depth across the whole implement from one seeding depth to another.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a side view of an embodiment of a furrow opener apparatus of the present invention with the packer wheel at the lowest position relative to the furrow opener in the range of movement, such that the furrow opener is at the highest position relative to the ground;

FIG. 2 is a rear perspective view of the actuator and indicator of the embodiment of FIG. 1 in the position of FIG. 1;

FIG. 3 is a side view of the embodiment of FIG. 1 with the packer wheel at the highest position relative to the furrow opener in the range of movement, such that the furrow opener is at the lowest position relative to the ground;

FIG. 4 is a rear perspective view of the actuator and indicator of the embodiment of FIG. 1 in the position of FIG. 3;

FIG. 5 is a schematic side view showing arm and bracket indicator members of different shapes so as to be differentiated visually;

FIG. 6 is a schematic top view of an seeding apparatus of the present invention with a plurality of furrow opener apparatuses of FIG. 1 mounted thereon;

FIG. 7 is a front perspective view of an alternate embodiment of a furrow opener apparatus of the present invention with two furrow openers and where the packer wheel is movably mounted to the end of the trailing arm by a vertical shaft slidable in a tube;

FIG. 8 is a rear perspective of the actuator and indicator of the embodiment of FIG. 7.

### DETAILED DESCRIPTION OF THE ILLUSTRATED EMBODIMENTS

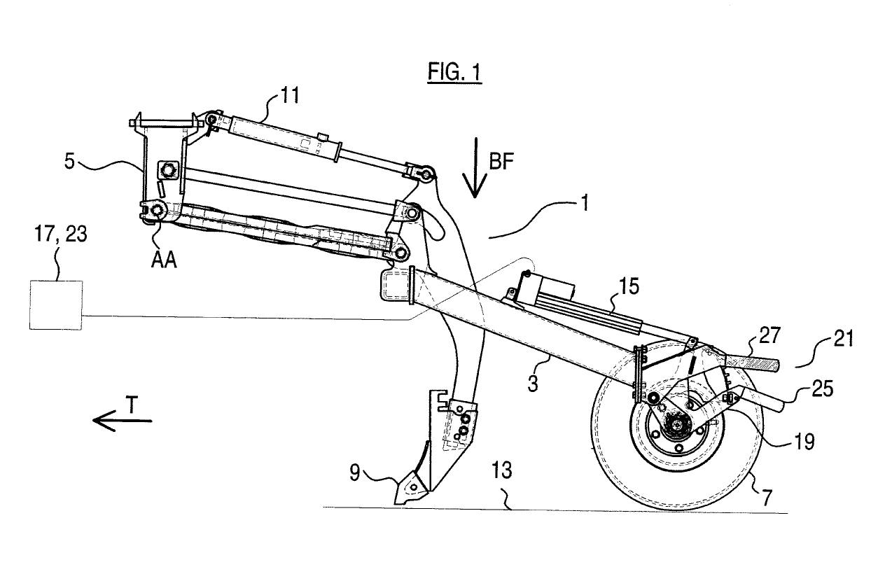

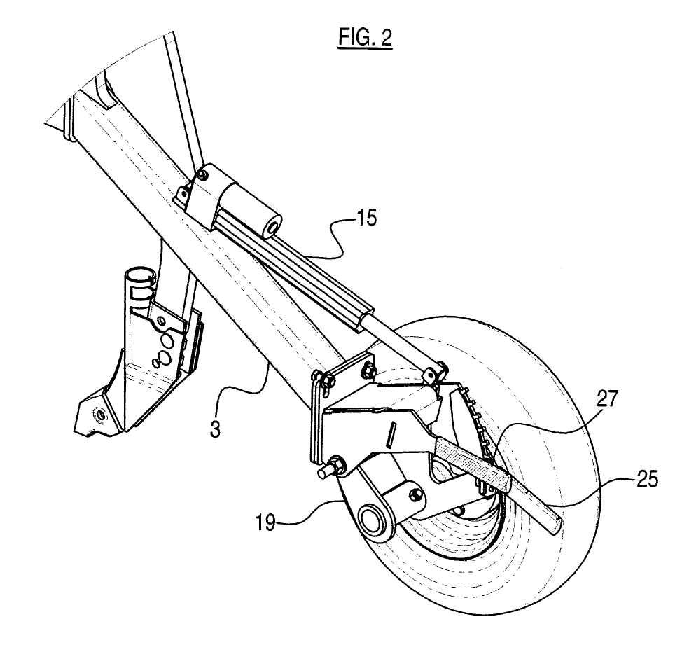

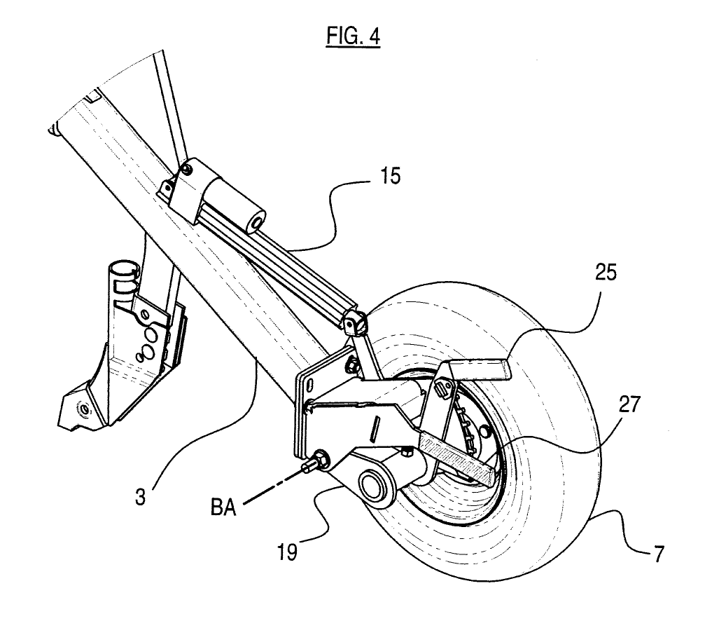

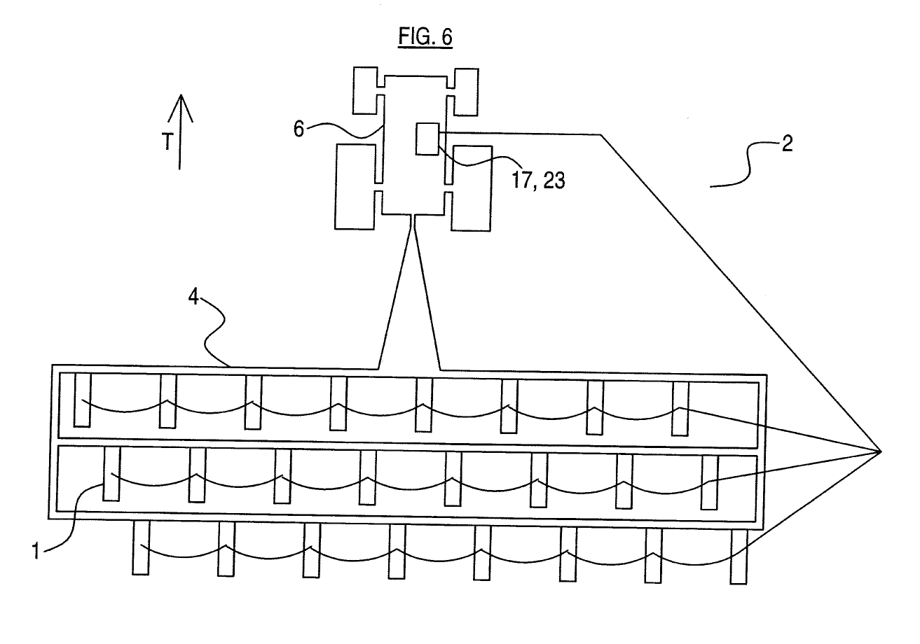

FIGS. 1-4 schematically illustrate an embodiment of a furrow opener assembly 1 of the present invention. The assembly 1 comprises a trailing arm 3 adapted at a front end thereof to be pivotally attached about an arm pivot axis AA to a frame member 5 of an implement frame 4 supported for movement along the ground by a towing vehicle 6 in an operating travel direction T as schematically illustrated in FIG. 6. Larger implements will typically be supported on wheels however smaller implements may be mounted directly to the towing vehicle by a three point hitch or the like.

The arm pivot axis AA is oriented substantially horizontally and transverse to the operating travel direction T, and the trailing arm 3 extends rearward from the frame member 5. In the illustrated assembly 1, the trailing arm 3 includes a parallel link however those skilled in the art will recognize that the assembly 1 would work equally well where the trailing arm 3 is a single arm from the front end to the rear end thereof.

A packer wheel 7 is rotatably mounted at a rear end of the trailing arm 3, and a furrow opener 9 is mounted to the trailing arm 3 forward of, and substantially in alignment with, the packer wheel 7. The illustrated furrow opener 9 is a knife type opener, but a single or double disc furrow opener could be used as well. A bias element, illustrated as a hydraulic cylinder 11, is operative, in an operating mode, to exert a downward bias force BF on the trailing arm 3 with respect to the implement frame member 5 such that the packer wheel 7 is forced downward against the ground 13.

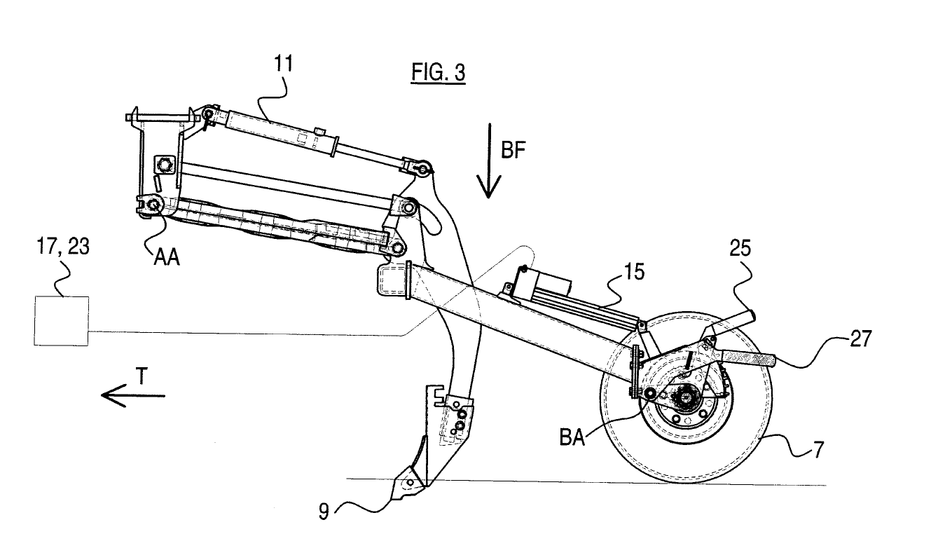

An actuator 15 is operative to move the packer wheel 7 up and down through a range from a lowest vertical position with respect to the furrow opener 9, as illustrated in FIG. 1, to a highest vertical position with respect to the furrow opener 9, as illustrated in FIG. 3. A remote control 17 is operative to activate the actuator 15 from the towing vehicle. Although it is contemplated that other actuators could be used, in the illustrated assembly 1 the actuator 15 is an extendable actuator, such as an electric screw type actuator or hydraulic cylinder. The actuator 15 is fully extended in the position of FIG. 1 and fully retracted in the position of FIG. 3.

FIG. 1 illustrates the lowest vertical position of the packer wheel 7 with respect to the furrow opener 9, which corresponds to the highest position of the furrow opener 9 with respect to the ground 13 when the hydraulic cylinder 11 is in the operating mode pushing the packer wheel 7 against the ground. Here with the packer wheel 7 in the lowest vertical position with respect to the furrow opener 9, the furrow opener 9 is above the ground 13. In some circumstances it may be desirable to be able to raise the furrow openers 9 out of the ground entirely as shown, or alternatively the assembly 1 can be configured to move the range of vertical motion of the furrow openers 9 to any other desired relationship with the surface of the ground 13.

Also if desired, certain furrow openers 9, such as those in the wheel tracks of the towing vehicle, can be set at a different level than the other furrow openers 9, and then move up and down the same distance as the other furrow openers when the remote control is operated.

FIG. 3 illustrates the highest vertical position of the packer wheel 7 with respect to the furrow opener 9, which corresponds to the lowest position of the furrow opener 9 with respect to the ground 13, and thus the deepest furrow depth.

FIG. 6 schematically illustrates a seeding implement 2 of the invention. The seeding implement 2 comprises an implement frame 4 with a plurality of frame members, and the implement frame is supported for movement along the ground by a towing vehicle 6 in an operating travel direction T. A plurality of furrow opener assemblies 1 are attached to the implement frame 4 in three rows.

On the seeding apparatus 2, the remote control 17 is provided by a microprocessor that is programmed and operative to activate the actuators 15 of the plurality of furrow opener assemblies 1 to move the packer wheels 7 of all the furrow opener assemblies 1 up or down an equal selected distance. Thus the operator can input a seeding depth increase of two centimeters into the microprocessor remote control 17, and the microprocessor remote control 17 will activate the actuators 15 of all the assemblies 1 accordingly.

Depending on the type of actuators 15 used and any limitations with respect to powering or controlling the actuators, the microprocessor remote control 17 can be programmed and operative to activate the actuators sequentially or simultaneously. Where the actuators 15 are activated simultaneously of course the time to achieve the depth change across the entire implement 2 will be short, however this may not be practically possible.

Where electrical actuators are used on a wide implement for example, it may be problematic to provide sufficient electrical power to activate 80 or more actuators 15 at the same time, and so the actuators could be activated sequentially such that electrical power is only required to operate one actuator at a time.

In that case where on each individual actuator is activated sequentially, it will take some time to achieve the depth change across the entire implement. For example in an implement with 80 furrow opener assemblies 1, if each actuator 15 is activated for two seconds, it will take about 160 seconds. While this may not be a problem in most situations, it may be problematic where it is desired to change seeding depth while travelling down the field to adjust for varying soil conditions.

It may thus be desirable to configure the furrow opener assemblies 1 in groups, and then activate the actuators 15 of all the furrow opener assemblies 1 in one group simultaneously to simultaneously adjust the seeding depth of all the furrow openers in that group, and when the furrow openers in that group have been adjusted to a desired seeding depth, activate the actuators 15 of all the furrow opener assemblies 15 in the next group simultaneously to simultaneously adjust the seeding depth of all the furrow openers in the that next group to the desired seeding depth, and so on until all groups have been adjusted.

Then with the implement with 80 furrow opener assemblies 1, it may be determined that there is sufficient electrical power to operate 10 actuators at a time, and so the actuators could be grouped into eight groups of ten and the remote control microprocessor 17 programmed so that ten actuators were activated at a time, and the actuators of the eight groups were activated in sequence. Then the time to achieve the depth change across the entire implement, again if each actuator 15 is activated for two seconds, will only be about 16 seconds, which may be suitable for on the go depth changes.

In the assembly 1 of FIGS. 1-4, the packer wheel 7 is rotatably mounted to a packer wheel bracket 19, and the packer wheel bracket 19 is pivotally attached to the rear end of the trailing arm 3 about a bracket axis BA oriented substantially horizontally and transverse to the operating travel direction T. The actuator 15 is operative to pivot the packer wheel bracket 19 about the bracket axis BA to move the packer wheel 7 up and down.

The assembly 1 has an indicator 21 operative to visibly indicate the vertical position of the packer wheel 7 with respect to the furrow opener 9. The indicator 21 allows for a quick visual check of the operation of the assembly 1. In practice, as schematically illustrated in FIG. 6, the seeding implement to which the assembly 1 will be attached will typically have three or four parallel rows of assemblies 1 arranged from the front to the rear of the implement frame 4. In wider implements, there can be 80 or more assemblies 1 mounted on the implement frame 4. The indicator allows a person standing behind the assemblies 1 to visually check that the relative positions of the packer wheel 7 and furrow opener 9 on each assembly are as desired.

The indicator 21 is further conveniently operative to indicate the vertical position of the packer wheel 7 with respect to the furrow opener 9 on each assembly 1 to an operator in the towing vehicle 6 through a remote indicator 23 located adjacent to the remote control 17 for the actuator 15.

As with any mechanism there is the risk that the system will fail, and that one or more furrow openers 9 will be at an improper depth, or simply riding along the surface, with detrimental effects on the crop such as uneven plant emergence. The indicator 21 is plainly visible allowing a person to periodically walk along behind the implement frame 4 and look to see if the indicators 21 are all showing the same position, and thus detect failure. Even electronic sensing, such as is used with the remote indicator 23, that indicates the depth of each furrow to the operator in the towing vehicle 6 could fail—and so the ease of manual inspection provided by the visible indicator 21 is beneficial.

In the assembly 1 of FIGS. 1-4, the indicator 21 comprises a bracket indicator member 25 fixed to the packer wheel bracket 19 and extending rearward from the packer wheel bracket 19, and an arm indicator member 27 fixed to the trailing arm 3 and extending rearward from the trailing arm 3. In the illustrated indicator 21, the relative positions of the bracket and arm indicator members 25, 27 visually indicates the relative positions of the packer wheel 7 and furrow opener 9. To make it easier to distinguish the indicator members 25, 27 the bracket indicator member 25 can be made visually differentiable from the arm indicator member 27.

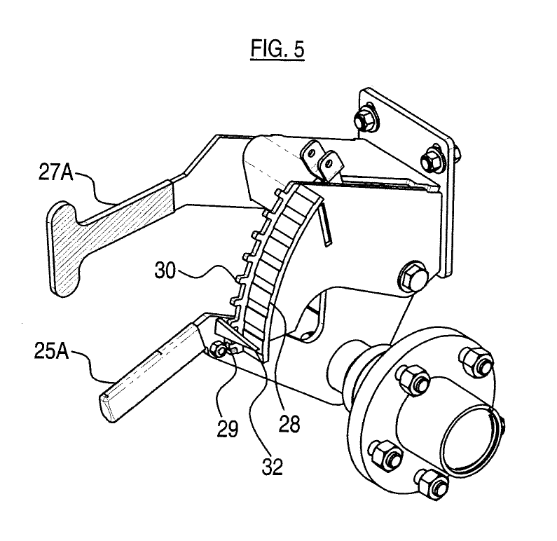

In the FIGS. 1-4 the arm indicator member 27 is shaded to indicate that same is a different color compared to the bracket indicator member 25. Alternatively FIG. 5 illustrates a bracket indicator member 27A that is made visually differentiable from the arm indicator member 25A by being a different shape. FIG. 5 also shows an indicator plate 28 extending laterally, and an indicator arrow 32 mounted on the handle 27A and extending over the indicator plate 28 to show the depth.

A manual override is also shown in FIG. 5 where a bracket 29 is bolted to the handle 27A to engage the handle 27A with the notches 30 on the indicator plate 28 to fix the depth in case of failure of the actuator.

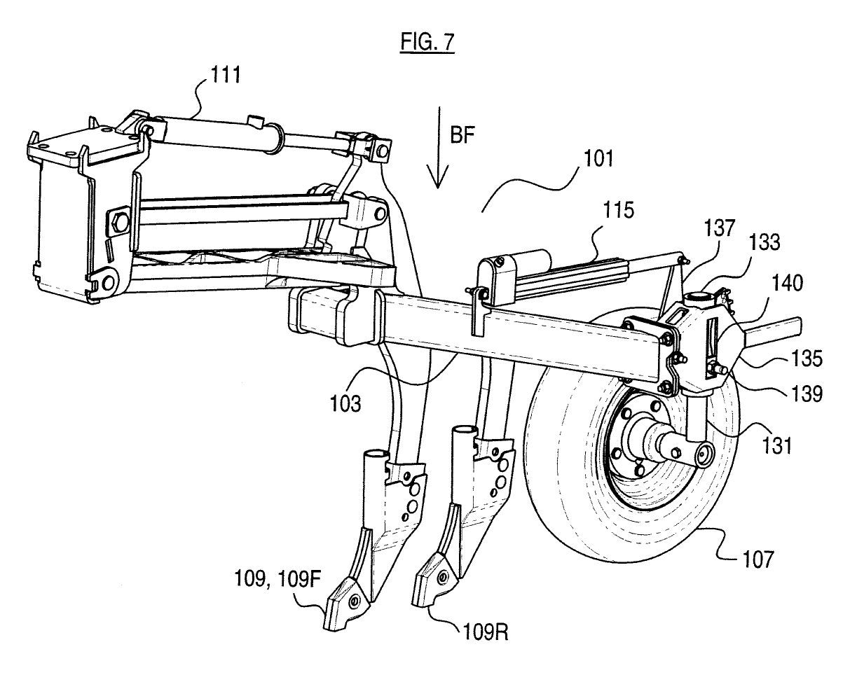

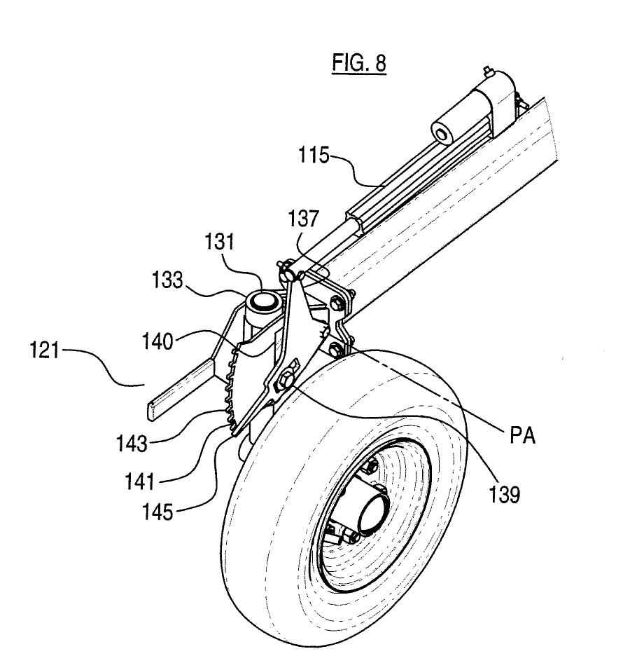

FIGS. 7 and 8 illustrate an alternate embodiment of a furrow opener assembly 101 of the present invention. The assembly 101 comprises a trailing arm 103, and a packer wheel 107 rotatably mounted at the rear end of the trailing arm 103, and a furrow opener 109 mounted to the trailing arm 103 forward of, and substantially in alignment with, the packer wheel 107. A hydraulic cylinder 111, is operative, in an operating mode, to exert a downward bias force BF on the trailing arm 103 and force the packer wheel 107 downward against the ground.

As described above, an actuator 115 is operative to move the packer wheel 107 up and down through a range from a lowest vertical position with respect to the furrow opener 109, to a highest vertical position with respect to the furrow opener 109, and a remote control is operative to activate the actuator 115 from the towing vehicle. In this assembly 101, the packer wheel 107 is rotatably attached to a substantially vertically oriented shaft 131 slidably engaged in a tube 133 fixed to the rear end of the trailing arm 103 by a tube bracket 135. The actuator 115 is linked to the shaft 131 by a pivot member 137. The pivot member 137 is pivotally attached to the tube bracket 135 about a pivot axis PA and a bolt 139 extends through the shaft 131 and through a hole 141 in a rearward portion of the pivot member 137 rearward of the pivot axis PA such that when the actuator 115 extends or retracts, the pivot member 137 pivots about the pivot axis PA and moves the bolt 139 up and down in the slot 140 and moves the shaft 131 in the tube 133 up or down.

The indicator 121 in the assembly 101 comprises a plate 141 with markings 143 along an edge thereof connected to the tube 133 and a pointer 145 connected to the shaft 131. In the illustrated indicator 121 the pointer is the pointed rear end of the pivot member 137 which is oriented to move along the edge of the plate 141 as the actuator 115 moves the packer wheel 107 up and down with respect to the furrow opener 109 by moving the shaft 131 up and down in the tube 133.

A manual over-ride mechanism is provided such that the vertical position of the packer wheel 107 with respect to the furrow opener 109 can be fixed to allow operations to continue if an actuator 115 should fail. The bolt 139 can be tightened to prevent the shaft 131 from sliding in the tube 133.

The assembly 101 comprises front and rear furrow openers 109F, 109R mounted to the trailing arm 103 forward of the packer wheel 107, with one of the front and rear furrow openers 109F, 109R substantially in alignment with the packer wheel 107.

To adjust the depth of seeding on a seeding apparatus with a plurality of trailing arm type furrow opener assemblies mounted on an implement frame, a remote control microprocessor is programmed to activate the actuators of all the plurality of furrow opener assemblies to move the packer wheels of all the furrow opener assemblies up or down an equal selected distance.

The present invention thus provides convenient adjustment of seeding depth for independent trailing arm type furrow openers. The system allows the operator to quickly change the seeding depth for larger or smaller seeds, or to suit wetter or drier soil conditions.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A furrow opener assembly comprising:
a trailing arm adapted at a front end thereof to be pivotally attached about an arm pivot axis to an implement frame supported for movement along the ground by a towing vehicle in an operating travel direction, the arm pivot axis oriented substantially horizontally and transverse to the operating travel direction, and the trailing arm extending rearward from the implement frame;
a packer wheel rotatably mounted at a rear end of the trailing arm;
a furrow opener mounted to the trailing arm forward of, and substantially in alignment with, the packer wheel;
a bias element operative, in an operating mode, to exert a downward bias force on the trailing arm with respect to an attached implement frame such that the packer wheel is forced downward against the ground;
an actuator operative to move the packer wheel up and down through a range from a lowest vertical position with respect to the furrow opener to a highest vertical position with respect to the furrow opener; and
a remote control operative to activate the actuator.

2. The assembly of claim 1 further comprising an indicator operative to visibly indicate the vertical position of the packer wheel with respect to the furrow opener.

3. The assembly of claim 2 wherein the indicator is operative to visibly indicate the vertical position of the packer wheel with respect to the furrow opener to a person standing behind the assembly.

4. The assembly of claim 3 wherein the indicator is further operative to indicate the vertical position of the packer wheel with respect to the furrow opener to an operator in the towing vehicle, and wherein the remote control is operated by the operator in the towing vehicle.

5. The apparatus of claim 1 wherein the packer wheel is rotatably mounted to a packer wheel bracket, and wherein the packer wheel bracket is pivotally attached to the rear end of the trailing arm about a bracket axis oriented substantially horizontally and transverse to the operating travel direction, and wherein the actuator is operative to pivot the packer wheel bracket about the bracket axis.

6. The assembly of claim 5 comprising an indicator operative to visibly indicate the vertical position of the packer wheel with respect to the furrow opener, wherein the indicator comprises a bracket indicator member fixed to the packer wheel bracket and extending rearward from the packer wheel bracket, and an arm indicator member fixed to the trailing arm and extending rearward from the trailing arm.

7. The assembly of claim 6 wherein the bracket indicator member is visually differentiable from the arm indicator member.

8. The assembly of claim 7 wherein the bracket indicator member is one of a different color and a different shape compared to the arm indicator member.

9. The apparatus of claim 1 wherein the packer wheel is rotatably attached to a substantially vertically oriented shaft slidably engaged in a tube fixed to the rear end of the trailing arm, and wherein the actuator is operative to move the shaft up and down in the tube.

10. The assembly of claim 9 comprising an indicator operative to visibly indicate the vertical position of the packer wheel with respect to the furrow opener, wherein the indicator comprises a plate with markings along an edge thereof connected to one of the tube and the shaft, and a pointer connected to the other of the tube and the shaft and oriented to move along the edge of the plate as the actuator moves the packer wheel up and down with respect to the furrow opener.

11. The apparatus of claim 1 configured such that when the bias element is in the operating mode and the packer wheel is in the lowest vertical position with respect to the furrow opener, the furrow opener is above the ground.

12. The apparatus of claim 1 further comprising a manual over-ride mechanism such that the vertical position of the packer wheel with respect to the furrow opener can be fixed.

13. The apparatus of claim 1 wherein the trailing arm comprises one of a single arm and a parallel link arm.

14. The apparatus of claim 1 comprising front and rear furrow openers mounted to the trailing arm forward of the packer wheel, and wherein one of the front and rear furrow openers is substantially in alignment with the packer wheel.

15. A seeding apparatus comprising a plurality of furrow opener assemblies according claim 1 mounted to an implement frame, and wherein the remote control comprises a microprocessor operative to activate the actuators of the plurality of furrow opener assemblies to move the packer wheels of all the furrow opener assemblies up or down an equal selected distance.

16. The apparatus of claim 15 wherein the microprocessor is operative to activate the actuators sequentially.

17. A seeding apparatus comprising:
an implement frame comprising a plurality of frame members, the implement frame supported for movement along the ground by a towing vehicle in an operating travel direction;
a plurality of furrow opener assemblies attached to the implement frame, each furrow opener assembly comprising:
a trailing arm pivotally attached at a front end thereof to a frame member about an arm pivot axis oriented substantially horizontally and transverse to the operating travel direction such that the trailing arm extends rearward from the frame member;
a packer wheel rotatably mounted at a rear end of the trailing arm;
a furrow opener mounted to the trailing arm forward of, and substantially in alignment with, the packer wheel;
a bias element operative, in an operating mode, to exert a downward bias force on the trailing arm such that the packer wheel is forced downward against the ground;
an actuator operative to move the packer wheel up and down through a range from a lowest vertical position with respect to the furrow opener to a highest vertical position with respect to the furrow opener; and
a remote control comprising a microprocessor operative to activate the actuators of the plurality of furrow opener assemblies to move the packer wheels of all the furrow opener assemblies up or down an equal selected distance.

18. The apparatus of claim 17 wherein the microprocessor is operative to activate the actuators sequentially.

19. The apparatus of claim 17 wherein the microprocessor is operative to activate at least two of the actuators simultaneously.

20. The apparatus of claim 19 wherein the furrow opener assemblies are configured in first and second groups, and wherein the microprocessor is operative to activate the actuators of all the furrow opener assemblies in the first group simultaneously to simultaneously adjust the seeding depth of all the furrow openers in the first group to a desired seeding depth, and when the furrow openers in the first group have been adjusted to a desired seeding depth, the microprocessor is operative to activate the actuators of all the furrow opener assemblies in the second group simultaneously to simultaneously adjust the seeding depth of all the furrow openers in the second group to the desired seeding depth.

21. The apparatus of claim 17 comprising an indicator operative to visibly indicate the vertical position of the packer wheel with respect to the furrow opener to a person standing behind the apparatus.

22. A method of adjusting a depth of seeding on a seeding apparatus, the method comprising:
providing an implement frame comprising a plurality of frame members, and supporting the implement frame for movement along the ground by a towing vehicle in an operating travel direction;
attaching a plurality of furrow opener assemblies to the implement frame, each furrow opener assembly comprising:
a trailing arm pivotally attached at a front end thereof to a frame member about an arm pivot axis oriented substantially horizontally and transverse to the operating travel direction such that the trailing arm extends rearward from the frame member;
a packer wheel rotatably mounted at a rear end of the trailing arm;
a furrow opener mounted to the trailing arm forward of, and substantially in alignment with, the packer wheel;
a bias element operative, in an operating mode, to exert a downward bias force on the trailing arm such that the packer wheel is forced downward against the ground;
an actuator operative to move the packer wheel up and down through a range from a lowest vertical position with respect to the furrow opener to a highest vertical position with respect to the furrow opener; and
providing a remote control comprising a microprocessor and programming the microprocessor to activate the actuators of the plurality of furrow opener assemblies to move the packer wheels of all the furrow opener assemblies up or down an equal selected distance.

23. The method of claim 22 comprising programming the microprocessor to activate the actuators sequentially.

24. The method of claim 22 comprising programming the microprocessor to activate at least two of the actuators simultaneously.

25. The method of claim 22 comprising providing an indicator operative to visibly indicate the vertical position of the packer wheel with respect to the furrow opener to a person standing behind the apparatus.
